(19) United States
(12) Patent Application Publication
(10) Pub. No.: US 2024/0330986 A1
(43) Pub. Date: Oct. 3, 2024

(54) SYSTEM AND METHOD FOR MANAGING ADVERTISEMENT INFORMATION, AND APPARATUS AND PROGRAM FOR DELIVERING ADVERTISEMENT INFORMATION

(71) Applicant: RISO KAGAKU CORPORATION, Tokyo (JP)

(72) Inventor: Akiko NOZAWA, Tokyo (JP)

(73) Assignee: RISO KAGAKU CORPORATION, Tokyo (JP)

(21) Appl. No.: 18/614,842

(22) Filed: Mar. 25, 2024

(30) Foreign Application Priority Data
Mar. 30, 2023 (JP) 2023-054508

(51) Int. Cl. G06Q 30/0273; G06Q 30/0251

(52) U.S. Cl. CPC G06Q 30/0273; G06Q 30/0265

(57) ABSTRACT

An advertisement information management system includes an advertisement information delivery apparatus that delivers advertisement information to a user who is aboard or is scheduled to board a means of transportation, and an advertiser terminal device that obtains purchase information in the case that the user views the advertisement information and purchases a subject of advertising.

### CROSS-REFERENCE TO RELATED APPLICATIONS

The present application claims priority under 35 U.S.C. § 119 to Japanese Patent Application No. 2023-054508, filed on Mar. 30, 2023. The above applications are hereby expressly incorporated by reference, in these entireties, into the present application.

### BACKGROUND OF THE INVENTION

### 1. Field of the Invention

The present disclosure is related to a system and a method for managing advertisement information, and an apparatus and a program for delivering advertisement information within a means of transportation such as a fixed route bus.

### 2. Description of the Related Art

Conventionally, advertising systems have been proposed that display advertisement information of stores near a route in a means of transportation such as a fixed route bus.

For example, Japanese Unexamined Patent Publication No 2008-145719 proposes an advertising system that outputs advertisement information of stores using a display device installed on a fixed route bus. This advertising system stores advertisement information of an advertiser's store and the location of the store, identifies a nearby bus stop based on the location of the store, and outputs the advertisement information of the store between bus stops whose routes include the bus stop.

### SUMMARY OF THE INVENTION

However, with the advertising system proposed in Japanese Unexamined Patent Publication No 2008-145719, advertisers cannot know whether advertisements they placed on the fixed route buses were effective. Thus, for example, if the advertiser pays for the cost of the advertisement when requesting to place the advertisement, there is a possibility that they may pay for an advertisement that has no advertising effect.

The present disclosure has been developed in view of the foregoing circumstances. The present disclosure provides a system and a method for managing advertisement information, and an apparatus and a program for delivering advertisement information that enable advertisers to pay costs for advertisement information that had an advertising effect.

An advertisement information management system is equipped with an advertisement information delivery unit that delivers advertisement information to a user who is on board or is scheduled to board a means of transportation, and a purchase information obtaining unit that obtains purchase information in the case that a user views the advertisement information and purchases a subject of advertising.

According to the advertisement information management system of the present disclosure, in the case that a user who is on board or a user who is scheduled to board the means of transportation views advertisement information and purchases a subject of advertising, so the purchase information is obtained, the advertiser can confirm the purchase information of the subject of advertising and pay the cost for the advertisement information which had an advertising effect.

### BRIEF DESCRIPTION OF THE DRAWINGS

FIG. 1 is a block diagram that illustrates the schematic configuration of one embodiment of an advertisement information management system of the present disclosure.

FIG. 2 is a diagram that illustrates an example of an advertisement information table.

FIG. 3 is a flowchart for explaining the processes which are performed by the advertisement information management system illustrated in FIG. 1.

FIG. 4 is a block diagram that illustrates the schematic configuration of another embodiment of the advertisement information management system.

FIG. 5 is a flowchart for explaining the processes which are performed by the advertisement information management system illustrated in FIG. 4.

### DETAILED DESCRIPTION OF THE EMBODIMENTS

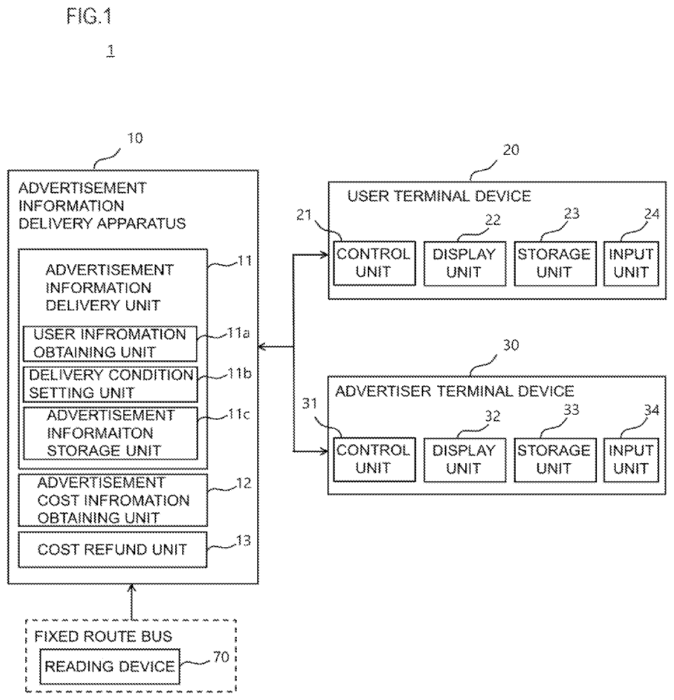

An advertisement information management system 1 that employs one embodiment of an advertisement information delivery system will be described in detail with reference to the drawings. FIG. 1 is a block diagram that illustrates the schematic configuration of the advertisement information management system 1.

The advertisement information management system 1 of the present embodiment is a system that delivers advertisement information to users within fixed route buses. In the advertisement information management system 1 of the present embodiment, in the case that a user purchases a subject of advertising by the advertisement information after viewing the advertisement information, purchase information is obtained by an advertiser terminal device 30. If the advertiser confirms the purchase information and pays the cost for the advertisement information for the subject of advertisement, the cost of the advertisement information is obtained by an advertisement information delivery apparatus 10, and the system refunds part of the cost of the advertisement information to the user who has viewed the advertisement information. Note that in the present disclosure, a user is a person who is on board or is scheduled to board a means of transportation such as a fixed route bus, and is also a user of the advertisement information management system 1.

In the present embodiment, a fixed route bus corresponds to the means of transportation of the present disclosure. However, the means of transportation of the present disclosure is not limited to fixed route buses, but can also be other means of transportation such as a local community bus, a train, a taxi, and a ship.

Specifically, the advertisement information management system 1 of the present embodiment is equipped with the advertisement information delivery apparatus 10, a user terminal device 20 of a user on a fixed route bus, and the advertiser terminal device 30, as illustrated in FIG. 1. In the present embodiment, the advertiser terminal device 30 corresponds to the purchase information obtaining unit of the present disclosure.

The user terminal device 20 and the advertiser terminal device 30 are connected to the advertisement information delivery apparatus 10 via communication lines such as the Internet or LAN (Local Area Network) lines, and are configured to be capable of exchanging various types of information with each other.

The following is a more detailed description of each of the devices that constitute the advertisement information management system 1.

As illustrated in FIG. 1, the advertisement information delivery apparatus 10 is equipped with an advertisement information delivery unit 11, an advertising cost information obtaining unit 12, and a cost refund unit 13.

The advertisement information delivery unit 11 delivers advertisement information to the user terminal device 20 of a user who boarded a fixed route bus. The advertisement information delivery unit 11 is equipped with a user information obtaining unit 11a, a delivery condition setting unit 11b, and an advertisement information storage unit 11c.

The user information obtaining unit 11a obtains information regarding a user who boarded the fixed route bus. The user information obtaining unit 11a in the present embodiment obtains user information from a transportation system IC application which is installed in advance in the user terminal device 20.

Specifically, in the case that a user boards a fixed route bus, the user holds the user terminal device 20 over a reading device 70 installed in the bus. The user terminal device 20 communicates with the reading device 70, and user information is read from the transportation system IC application in the terminal device 20. The user information is transmitted from the reading device 70 of the bus to the advertisement information delivery apparatus 10 via wireless communication lines and is obtained by the user information obtaining unit 11a.

The user information includes the identification of the user terminal device 20, the user's identification information, gender, and age, the location where the user boarded the fixed route bus, and the time the user boarded the fixed route bus, for example. If the user's transportation system IC application is a commuter pass, the user information also includes the boarding and disembarking locations of the commuter pass.

For example, the location where the user boarded the fixed route bus may be obtained from bus stop information obtained by the reading device 70 at the time the user terminal device 20 was read by the reading device 70, or from location information obtained by a GPS (Global Positioning System) function of the user terminal device 20. The user may also set and enter a planned destination location on the user terminal device 20 and the planned destination location may be included in the user information.

The advertiser's advertisement information delivery conditions are set in advance in the delivery condition setting unit 11b. The advertisement information delivery conditions are conditions under which the advertiser wishes to deliver the advertisement information. For example, the advertisement information delivery conditions include a delivery location (delivery route), a delivery time period, a target age group, and a target gender. The advertisement information delivery conditions can be set separately for each advertiser.

The advertisement information delivery unit 11 delivers advertisement information to the user terminal device 20 based on the results of comparing the user information which is obtained by the user information obtaining unit 11a with the advertisement information delivery conditions which are set in the delivery condition setting unit 11b.

If the delivery location (delivery route), the delivery time period, the target age group, and the target gender of the user in the advertisement information delivery conditions match the boarding location, the boarding time, the age, and the gender in the user information, for example, the advertisement information is delivered to the user terminal device 20 based on the identification information of the user terminal device 20 of the user which is included in the user information.

The advertisement information delivery unit 11 may also obtain the location information of the user terminal device 20, and when the user approaches a predetermined stop, it may deliver advertisement information for stores near that stop.

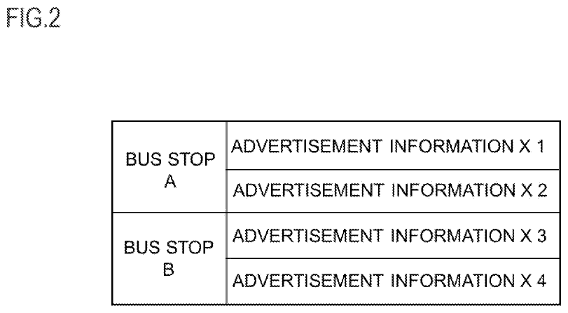

Specifically, the advertisement information delivery unit 11 stores the route of the fixed route bus and the location information of the stops along the route. Then, when the distance between the user's location information and the location information of a stop becomes equal to or less than preset threshold value, the advertisement information delivery unit 11 refers to the advertisement information table illustrated in FIG. 2 and transmits the advertisement information associated with the stop (advertisement information of stores near the stop) to the user terminal device 20 on board the fixed route bus.

In the case that the distance between the user's location information and the location information of stop A becomes equal to or less than the threshold value, the advertisement information delivery unit 11 delivers advertisement information X1 and X2 to the user terminal device 20, for example.

In addition, in the case that the distance between the user's location information and the location information of stop B becomes equal to or less than the threshold value, the advertisement information delivery unit 11 delivers advertisement information X3 and X4 to the user terminal device 20, for example.

The advertisement information storage unit 11c stores advertisement information that has been requested to be displayed by advertisers. The advertisement information is stored in association with, for example, the advertisement information delivery conditions. The advertisement information storage unit 11c also stores the advertisement information table illustrated in FIG. 2.

The advertisement information delivery unit 11 may also search for advertisement information in response to a search performed by a user and deliver the advertisement information which was searched for.

In the case that the search information “If there is a restaurant on the way to my destination, I want to get off before the destination and eat” and the user's destination information is input into the user terminal device 20, for example, the advertisement information delivery unit 11 searches for advertisement information for restaurants that have delivery locations set between the user's boarding location and the destination location. If advertisement information for a restaurant is found, the advertisement information delivery unit 11 delivers the advertisement information to the user terminal device 20.

In the case that the search information “I will not get off before my destination but want to know about stores near my destination” and the user's destination information are input into the user terminal device 20, for example, the advertisement information delivery unit 11 searches for advertisement information having a delivery location set between the location where the user boarded the bus and the destination, and having a delivery location set near the destination. If advertisement information for a store near the destination is found, the advertisement information delivery unit 11 delivers the advertisement information to the user terminal device 20.

Note that the user search information is not limited to the above examples, and any other search information may be set.

In addition, the advertisement information delivery unit 11 may receive information on a ticket purchased in advance by the user and deliver advertisement information to the user terminal device 20 based on information regarding the ticket, for example. In other words, the advertisement information may be delivered to the user terminal device 20 of a user who is scheduled to board a fixed route bus. Specifically, the advertisement information delivery unit 11 may obtain information regarding the date, the time, and the route to be used from the ticket which is purchased in advance, identify advertisement information that matches the obtained information in terms of delivery time zone and delivery location (delivery route), and deliver the information to the user terminal device 20. The advertisement information delivery unit 11 may also deliver the advertisement information to the user terminal device 20 in advance of the scheduled date and time that the ticket is to be used.

Next, the advertising cost information obtaining unit 12 obtains information regarding the cost of the advertisement information for advertised product or service in the case that a user of the fixed route bus views the advertisement information and purchases the advertised product or service.

In the case that a user of a fixed route bus views advertisement information and purchases a product or service which is the subject of advertising, purchase information is transmitted from the user terminal device 20 to the advertiser terminal device 30. The purchase information includes the identification information of the user terminal device 20. The purchase information may be transmitted from a purchase site to the advertiser terminal device 30 when the user accesses the purchase site using the terminal device 20 and purchases a product or service to be advertised, for example.

In addition, in the case that a user visits a restaurant or other store of the advertised information and receives services, the purchase information is obtained by reading the user terminal device 20 at the store's terminal device, that is, the advertiser terminal device 30, for example.

For purchase information in the case that a user purchases a product or service to be advertised using an electronic payment application which is installed on the terminal device 20, the purchase information may be transmitted to the advertiser terminal device 30 from the service usage history and product purchase history of the electronic payment application, for example. The purchase information may also be sent from the user terminal device 20 to the advertiser terminal device 30 by the user taking a picture of a receipt using the terminal device 20.

The purchase information is then received by the advertiser terminal device 30, and the content of the purchase information is confirmed by an advertiser. After the advertiser confirms the purchase information, the advertiser uses the advertiser terminal device 30 to input and set the cost information for the advertisement information with respect to the purchased product or service based on the purchase information. Then, the advertiser terminal device 30 transmits the information regarding the cost of the advertisement information, which has been input and set, to the advertisement information delivery apparatus 10, together with the identification information of the user terminal device 20 and identification information of the advertisement information.

The advertising cost information obtaining unit 12 obtains information regarding the cost of advertisement information transmitted from the advertiser terminal device 30.

When the information regarding the cost of advertisement information is obtained by the advertising cost information obtaining unit 12, the cost refund unit 13 refunds a portion of the cost for that advertisement information to the user.

Specifically, the cost refund unit 13 calculates the portion of the cost by multiplying the cost of the advertisement information by a predetermined rate, for example. Then, based on the identification information of the user terminal device 20, the cost refund unit 13 transmits the information regarding the portion of the cost to the user terminal device 20 to load the transportation system IC application or the electronic payment application.

The cost refund unit 13 may change the rate in calculating a portion of the cost, for example, according to the amount or type of payment for the subject of advertising by the advertisement information, or according to attributes of an advertiser. The cost refund unit 13 may increase the cost of the advertisement information and the refund rate the higher the amount of the subject of advertising, or increase the refund rate for a subject of advertising specified by the advertiser, for example. The cost refund unit 13 may also use a refund rate specified for each advertiser.

The advertisement information delivery apparatus 10 is equipped with a CPU (Central Processing Unit), semiconductor memory such as a ROM (Read Only Memory) and a RAM (Random Access Memory), a storage such as a hard disk, and a communication I/F (Interface).

An embodiment of an advertisement information delivery program of the present disclosure is installed in the storage of the advertisement information delivery apparatus 10. When the advertisement information delivery program is activated by the CPU, the aforementioned functions of the advertisement information delivery apparatus 10 are executed.

In the present embodiment, the functions of each of the units are performed by executing the advertisement information delivery program by the CPU, but some or all of the functions performed by the advertisement information delivery program may be performed by hardware such as an ASIC (Application Specific Integrated Circuit), a FPGA (Field-Programmable Gate Array), or other electric circuits.

Next, the user terminal device 20 will be described.

The user terminal device 20 is utilized by a user of a fixed route bus, as described above, and is constituted by a mobile device such as a tablet terminal or a smartphone, for example.

The user terminal device 20 is equipped with a control unit 21, a display unit 22, a storage unit 23, and an input unit 24, as illustrated in FIG. 1. The control unit 21 controls the entire user terminal device 20. Particularly, the control unit 21 receives advertisement information which is delivered from the advertisement information delivery apparatus 10 and displays the advertisement information on the display unit 22.

In addition, in the case that a user accesses a purchase site where the subject of advertising by the advertisement information is available and purchases the subject of advertising, the control unit 21 sends the purchase information described above to the advertiser terminal device 30, for example.

Further, when the transportation system IC application which is installed in advance is read by the reading device 70 of the fixed route bus, the control unit 21 transmits the user information described above from the application to the advertisement information delivery apparatus 10.

The display unit 22 is equipped with a display device such as a liquid crystal display. In the case that the terminal device 20 is a tablet terminal or a smartphone, the touch panel that the tablet terminal or smartphone has is the display unit 22.

The input unit 24 receives setting and input of various types of information from the user.

The aforementioned functions of the user terminal device 20 may be realized by the functions of applications which are installed in advance in the hard disk of the user terminal device 20, or by using applications provided via a web browser.

Next, the advertiser terminal device 30 will be described. The advertiser terminal device 30 is used by an advertiser who provides advertisement information as described above, and is constituted by a desktop PC, a laptop PC, or a mobile terminal such as a tablet terminal, for example.

The terminal device 30 has a control unit 31, a display unit 32, a storage unit 33, and an input unit 34, as illustrated in FIG. 1. The control unit 31 controls the entire terminal device 30. Particularly, the control unit 31 reads out the advertisement information stored in the storage unit 33 and transmits it to the advertisement information delivery apparatus 10 together with a request to place an advertisement to register the advertisement information.

In the case that a product, a service, or the like which is the subject of advertising by the advertisement information is purchased, the control unit 31 receives the purchase information and displays it on the display unit 32.

In addition, in the case that information regarding the cost of advertisement information with respect to the purchase information is set and input, the control unit 31 transmits the information to the advertisement information delivery apparatus 10 together with the purchase information.

The display unit 32 has a display device such as a liquid crystal display. In the case that the terminal device 30 is a tablet terminal, the touch panel of the tablet terminal is the display 32.

The storage unit 33 stores advertisement information, purchase information, and information regarding the cost of advertisement information.

The input unit 34 receives setting and input of various types of information by the advertiser. Particularly, the input unit 34 receives setting input of the cost information of the advertisement information.

The aforementioned functions of the advertiser terminal device 30 may be realized by the functions of applications which are installed in advance on the hard disk of the advertiser terminal device 30, or by using applications provided via a web browser.

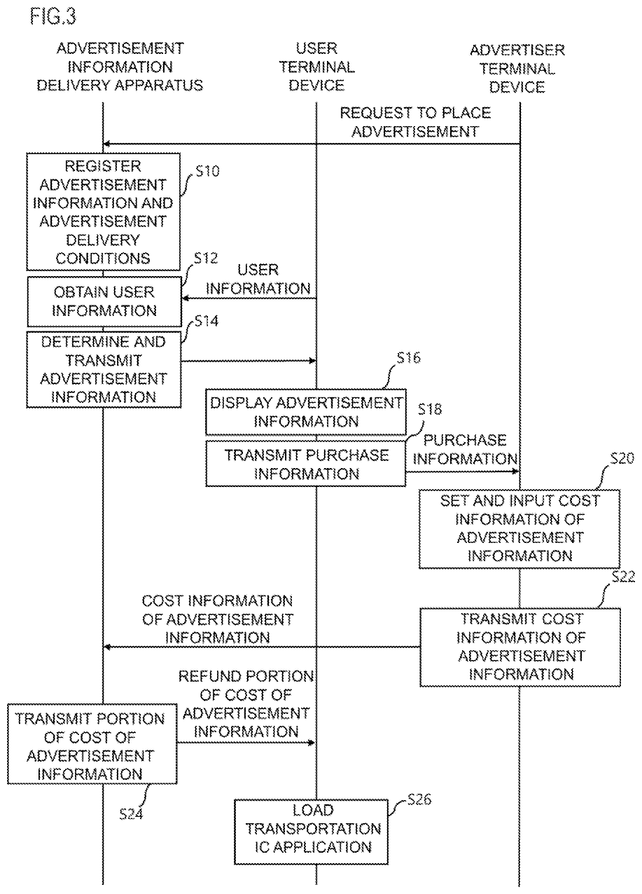

Next, the flow of processes which are performed by the advertisement information management system 1 of the present embodiment will be described with reference to the flowchart illustrated in FIG. 3.

First, the advertiser transmits a request to place an advertisement, which includes advertisement information and advertisement information delivery conditions, to the advertisement information delivery apparatus 10 to register the request to place an advertisement using the advertiser terminal device 30 (S10).

Next, a user of a fixed route bus boards the fixed route bus, has the user terminal device 20 read by the reading device 70 of the fixed route bus, user information is transmitted from the reading device 70 to the advertisement information delivery apparatus 10, and the user information is obtained by the advertisement information delivery apparatus 10 (S12).

The advertisement information delivery apparatus 10 determines advertisement information to be transmitted based on the input user information and the advertisement information delivery conditions, and transmits the advertisement information to the user terminal device 20 (S14). The transmitted advertisement information is displayed by the user terminal device 20 (S16).

If the advertisement information is viewed by the user and the user purchases a product or service which is the subject of advertising in the advertisement information, purchase information is transmitted from the user terminal device 20 to the advertiser terminal device 30 (S18).

The purchase information which is received by the advertiser terminal device 30 is then confirmed by the advertiser, and the advertiser sets and inputs information regarding the cost of advertisement information with respect to the purchase information (S20).

The information regarding the cost of the advertisement information which is set and input by the advertiser is transmitted from the advertiser terminal device 30 to the advertisement information delivery apparatus 10 together with the identification information of the user terminal device 20 and the advertisement information (S22).

The advertisement information delivery apparatus 10 calculates a portion of the cost of the advertisement information as a cost to be refunded to the user, transmits information regarding the cost to be refunded to the user terminal device 20 based on the identification information of the user terminal device 20 (S24), and loads the transportation system IC application on the user terminal device 20, etc. (S26).

Note that in the advertisement information management system 1 of the embodiment described above, the advertiser terminal unit 30 obtains the purchase information of the subject of advertising, pays the cost of the advertisement information based on the purchase information, and transmits the information regarding the cost of the advertisement information to the advertisement information delivery apparatus 10. However, the present disclosure is not limited to such a configuration. The advertisement information delivery apparatus 10 may obtain the purchase information, determine the cost of the advertisement information, and transmit the information regarding the cost of the advertisement information to the advertiser terminal device 30 as billing information.

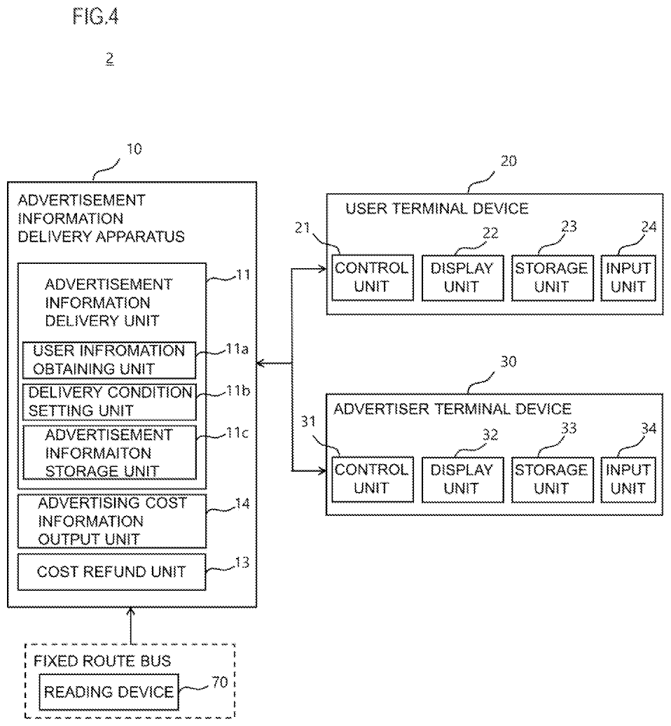

FIG. 4 is a diagram that illustrates the configuration of an advertisement information management system 2 that performs the process described above. An advertisement information delivery apparatus 10 of the advertisement information management system 2 illustrated in FIG. 4 is equipped with an advertising cost information output unit 14 instead of the advertising cost information obtaining unit 12 illustrated in FIG. 1. In the advertisement information management system 2, the advertisement information delivery apparatus 10 corresponds to the purchase information obtaining unit of the present disclosure.

In the case that a user views advertisement information and purchases a subject of advertising, the advertising cost information output unit 14 determines information regarding the cost of the advertisement information and transmits it to the advertiser terminal device 30. As a method for determining information regarding the cost of the advertisement information, an advertising cost table that correlates the identification information of the advertisement information to information on its cost may be set in advance, for example. Then, based on the identification information of the advertisement information viewed by the user transmitted from the user terminal device 20, the cost information of the advertisement information can be determined by referring to the above advertising cost table.

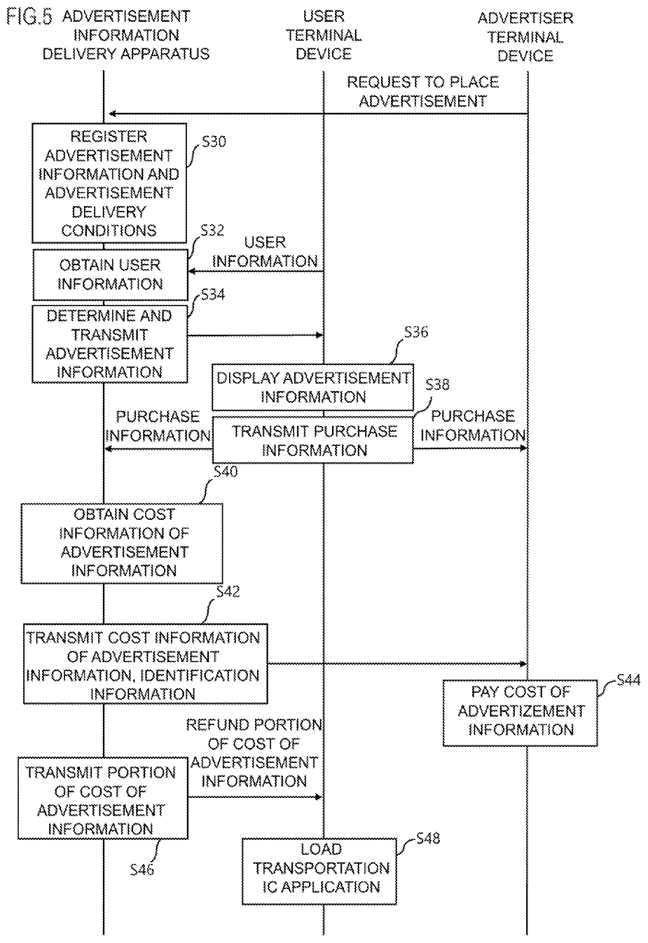

FIG. 5 is a flowchart that illustrates the flow of processes performed by the advertisement information management system 2 illustrated in FIG. 4. The steps of the process from S30 through S36 in the flowchart illustrated in FIG. 5 are the same as steps of the process from S10 through S16 of the flowchart illustrated in FIG. 3.

In the flowchart illustrated in FIG. 5, when the user purchases the subject of advertising by the advertisement information, the identification information of the advertisement information and the identification information of the user terminal device 20 are transmitted from the user terminal device 20 to the advertisement information delivery apparatus 10 and the advertiser terminal device 30 as purchase information (S38).

Then, the advertisement information delivery apparatus 10 obtains the identification information of the advertisement information transmitted from the user terminal device 20 and the identification information of the terminal device 20, obtains information on the cost of the advertisement information by referring to the advertising cost table described above based on the identification information of the advertisement information (S40).

The advertisement information delivery apparatus 10 then transmits the identification information of the advertisement information and information on the cost of the advertisement information to the advertiser terminal device 30 (S42). The advertiser pays the cost based on the information on the cost of the advertisement information which is received by the terminal device 30 (S44).

Meanwhile, the advertisement information delivery apparatus 10 calculates a portion of the cost of the advertisement information as a cost to be refunded to the user, transmits information on the cost to the user terminal device 20 based on the user terminal device 20 identification information (S46), and loads an amount corresponding to the cost to the transportation system IC application, etc. of the user terminal device 20 (S48).

According to the advertisement information management systems 1 and 2 of the embodiments described above, in the case that a user views advertisement information while aboard a fixed route bus and purchases a subject of advertising, purchase information is obtained such that an advertiser can confirm the purchase information of the subject of advertising and pay for the advertisement information that had an advertising effect.

In addition, in the case that the advertisement information management systems 1 and 2 of the embodiments described above refund a portion of the cost of the advertisement information to the user, the user will be motivated to ride the fixed route bus, thereby further promoting the viewing of advertisement information.

Further, in the case that the advertisement information management systems 1 and 2 of the embodiments described above change the information regarding the cost of advertisement information based on the amount of payment for the subject of advertising by the advertisement information, the advertiser can pay a cost of advertisement information which is commensurate with the user's purchase of the subject of advertising. In addition, if the refund rate to be applied to the amount of money which is refunded to the user is changed based on the amount paid for the subject of advertising by the advertisement information, the user will be more motivated to purchase the subject of advertising can be increased.

Still further, in the case that the advertisement information management systems 1 and 2 of the embodiments described above deliver the advertiser's advertisement information based on the advertisement information delivery conditions which are set by the advertiser, the advertisement information can be delivered at any timing desired by the advertiser.

In addition, in the case that the advertisement information management systems 1 and 2 of the embodiments described above deliver advertisement information according to search information for advertisement information input by a user, the user can view desired advertisement information, thereby increasing the user's willingness to purchase advertised products or services.

Note that in the advertisement information management system 1 of the embodiment described above, the advertisement information is displayed on the user terminal device 20. However, the present disclosure is not limited to such a configuration. The advertisement information may be displayed on a display device such as a monitor installed in a fixed route bus based on location information of the bus, for example. In this case, when a user uses the terminal device 20 to read a QR code (registered trademark) included in the advertisement information displayed on the monitor, the user may access a website where the product or service, which is a subject of advertising by the advertisement information, is available, and purchase the advertised product or service.

The present disclosure is not limited to the above embodiment, but can be embodied by modifying the components to the extent that it does not depart from the spirit thereof at the implementation stage. Also, various configurations can be formed by appropriate combinations of the plurality of components disclosed in the above embodiment. For example, all of the components of the embodiment may be combined as appropriate. It is, of course, possible to make various modifications and applications within a scope that does not depart from the purpose of the disclosure.

The following additional items are further disclosed with respect to the present disclosure.

### (Item 1)

An advertisement information management system of the present disclosure is equipped with: an advertisement information delivery unit that delivers advertisement information to a user who is aboard or is scheduled to board a means of transportation; and a purchase information obtaining unit that obtains purchase information in the case that the user purchases a subject of advertising after viewing the advertisement information.

### (Item 2)

The advertisement information management system of Item 1 may be equipped with a cost refund unit that refunds a portion of the cost of the advertisement information to the user.

### (Item 3)

In the advertisement information management system of Item 2, the cost refund unit may change information regarding the cost of the advertisement information or a refund rate to be refunded to the user based on the amount paid for the subject of advertising by the advertisement information.

### (Item 4)

In the advertisement information management system of any one of Items 1 to 3, the advertisement information delivery unit may receive advertisement information delivery conditions input by an advertiser and deliver the advertisement information based on the received advertisement information delivery conditions.

### (Item 5)

In the advertisement information management system of any one of Items 1 to 4, the advertisement information delivery unit may receive search information for the advertisement information input by the user and deliver advertisement information according to the received search information.

### (Item 6)

An advertisement information delivery apparatus of the present disclosure is equipped with: an advertisement information delivery unit that delivers advertisement information to a user who is aboard or is scheduled to board a means of transportation; and an advertising cost information obtaining unit that obtains information on the cost of advertisement information in the case that the user views the advertisement information and purchases a subject of advertising.

### (Item 7)

An advertisement information delivery apparatus of the present disclosure is equipped with: an advertisement information delivery unit that delivers advertisement information to a user who is aboard or is scheduled to board a means of transportation; and an advertising cost information output unit that outputs information on the cost of advertisement information in the case that the user views the advertisement information and purchases a subject of advertising.

### (Item 8)

An advertisement information management method of the present disclosure delivers advertisement information to a user who is aboard or is scheduled to board a means of transportation, and obtains purchase information in the case that the user views the advertisement information and purchases a subject of advertising.

### (Item 9)

An advertisement information delivery program of the present disclosure causes a computer to execute the steps of delivering advertisement information to a user who is aboard or is scheduled to board a means of transportation, and obtaining or outputting purchase information in the case that the user views the advertisement information and purchases a subject of advertising.

What is claimed is:

1. An advertisement information management system comprising:
an advertisement information delivery unit that delivers advertisement information to a user who is aboard or is scheduled to board a means of transportation; and
a purchase information obtaining unit that obtains purchase information in the case that the user purchases a subject of advertising after viewing the advertisement information.

2. The advertisement information management system as defined in claim 1, further comprising:
a cost refund unit that refunds a portion of the cost of the advertisement information to the user.

3. The advertisement information management system as defined in claim 2, wherein:
the cost refund unit changes information regarding the cost of the advertisement information or a refund rate to be refunded to the user based on the amount paid for the subject of advertising by the advertisement information.

4. The advertisement information management system as defined in claim 1, wherein:
the advertisement information delivery unit receives advertisement information delivery conditions input by an advertiser; and
delivers the advertisement information based on the received advertisement information delivery conditions.

5. The advertisement information management system as defined in claim 1, wherein:
the advertisement information delivery unit receives search information for the advertisement information input by the user; and
delivers advertisement information according to the received search information.

6. An advertisement information delivery apparatus comprising:
an advertisement information delivery unit that delivers advertisement information to a user who is aboard or is scheduled to board a means of transportation; and
an advertising cost information obtaining unit that obtains information on the cost of advertisement information in the case that the user views the advertisement information and purchases a subject of advertising.

7. An advertisement information delivery apparatus comprising:
an advertisement information delivery unit that delivers advertisement information to a user who is aboard or is scheduled to board a means of transportation; and
an advertising cost information output unit that outputs information on the cost of advertisement information in the case that the user views the advertisement information and purchases a subject of advertising.

8. An advertisement information management method comprising:
delivering advertisement information to a user who is aboard or is scheduled to board a means of transportation; and
obtaining purchase information in the case that the user views the advertisement information and purchases a subject of advertising.

9. A non-transitory computer-readable recording medium containing an advertisement information delivery program that causes a computer to execute the steps of:
delivering advertisement information to a user who is aboard or is scheduled to board a means of transportation; and
obtaining or outputting purchase information in the case that the user views the advertisement information and purchases a subject of advertising.
